(19) United States
(12) Patent Application Publication
(10) Pub. No.: US 2026/0158575 A1
(43) Pub. Date: Jun. 11, 2026

(54) METHOD FOR EFFICIENTLY MANAGING CONSUMABLES FOR WELDING CONSUMABLES

(71) Applicant: Airgas, Inc., Radnor, PA (US)

(72) Inventor: Scott LAYMON, Houston, TX (US)

(21) Appl. No.: 18/973,663

(22) Filed: Dec. 9, 2024

(51) Int. Cl. B23K 9/095; B23K 9/173

(52) U.S. Cl. CPC B23K 9/0953; B23K 9/173

(57) ABSTRACT

A method for monitoring and measuring the amount of filler metal used per a welding consumable including inputting into a consumable efficiency management system a target filler metal value, operating the welding system, thereby producing a real time usage value, continuously monitoring the real time usage value and continuously inputting the real time usage value into the consumable efficiency management system, thereby producing an aggregate value, and comparing the aggregate value with the target value. Wherein if the aggregate value is greater than or equal to the target value, the at least one welding consumable is replaced, and the aggregate value of the usage of the filler metal is reset to zero for that consumable and if the aggregate value is less than the target value and the method is repeated.

### BACKGROUND

There is a need in the industry to manage the usage of welding consumables in an efficient manner. These consumables include (but are not limited to) tips, nozzles, diffusers, liners, and torches. The current methods for managing the use of these consumables is either to run-to-fail, or establish a routine or set pattern for changing the consumables which is typically determined by tribal knowledge or basically guess work. For example, change at the beginning of a shift or day or change after a given number of welds or parts produced etc.

Excessive use of the consumables or running them to the point of failure can also be highly detrimental to productivity. As an example in GMAW/FCAW & MCAW, if too much wire is fed through a liner, or too much wire through a contact tip, either of which can result in feeding issues and in turn, can result in bird nesting at the drive rolls and/or “pinning” the wire to the contact tip which results in costly downtime. Too much wire being fed through a tip can result in an erratic arc and subsequently spatter issues. Typically, as the amount of wire that has been fed through the tip becomes excessive, the feed hole becomes larger and less round, thus resulting in poor and inconsistent contact between the wire and the tip.

While the costs of the consumables individually is not always relevant, there is also time associated with changing them out. Excess or unnecessary changeouts result in not only excess material costs but also loss of welding time which decreases productivity.

Gas Metal Arc Welding (GMAW) and Gas Tungsten Arc Welding (GTAW) processes utilize consumables which require replacement due to wear or damage. It is a challenge to know when a given consumable should be changed until there is an obvious failure. The typical solution is establishing a time frame for replacing the consumables such as a target number of operation hours, the beginning or end of a shift etc. In which case, consumables are often replaced when there is still significant life remaining in them. The alternative is running them to fail which is not a good option. This leads to more labor costs and downtime associated with the failure of the consumable which can in some cases result in weld quality issues and/or mechanical issues with the welding system such as bird nesting at the drive rolls, pinning a contact tip, erratic arc, weld porosity etc.

### SUMMARY

A method for monitoring and measuring the amount of filler metal used per a welding consumable is provided. This method includes inputting into a consumable efficiency management system, by means of a human-machine interface, a target filler metal value for at least one welding consumable to be used by a welding system. Operating the welding system, thereby producing a real time usage value of the filler metal by the at least one welding consumable. Continuously monitoring the real time usage value and continuously inputting the real time usage value into the consumable efficiency management system, thereby producing an aggregate value of the usage of the filler metal by the at least one welding consumable. And comparing the aggregate value with the target value. Wherein if the aggregate value is greater than or equal to the target value, the at least one welding consumable is replaced, and the aggregate value of the usage of the filler metal is reset to zero for that consumable. And wherein if the aggregate value is less than the target value, and the method is repeated.

A method for monitoring and measuring the amount of filler metal used per a welding consumable is provided. This method includes inputting into a consumable efficiency management system, by means of a human-machine interface, a target filler metal value for at least one welding consumable to be used by a welding system. Operating the welding system, thereby producing a real time usage value of the filler metal by the at least one welding consumable. Continuously monitoring the real time usage value and continuously inputting the real time usage value into the consumable efficiency management system, thereby producing an aggregate value of the usage of the filler metal by the at least one welding consumable. And, comparing the aggregate value with the target value. Wherein, if the aggregate value is greater than or equal to the target value, the at least one welding consumable is replaced, and the aggregate value of the usage of the filler metal is reset to zero. And wherein, if the aggregate value is less than the target value, assess the condition of the at least one welding consumable, and adjust the target value for the at least one welding consumable, and the method is repeated.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of the overall inventive process, in accordance with one embodiment of the present invention.

FIG. 2 is a schematic representation of an operator system interface, in accordance with one embodiment of the present invention.

FIG. 3 is a schematic representation of how the consumable targets and the real-time consumable usage are monitored by the operator, in accordance with one embodiment of the present invention.

### ELEMENT NUMBERS

101=target filler metal value
101a=target filler metal value for a diffuser
101b=target filler metal value for a liner
101c=target filler metal value for a tip
101d=target filler metal value for a nozzle
102=system usage
103=real time system usage of consumable
103a=real time system usage for the diffuser
103b=real time system usage for the liner
103c=real time system usage for the tip
103d=real time system usage for the nozzle
104=comparison between aggregate values and target filler metal value
105=actual aggregate value not equal to target filler metal value
106=actual aggregate value equal to target filler metal value
107=replace consumable
108=reset wire to consumable count

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

As used herein, “GMAW” is defined as gas metal arc welding.

As used herein, “FCAW” is defined as flux core arc welding.

As used herein, “consumable”, as pertains to FCAW, includes, but is not limited to, a tip, a nozzle (or cup), a diffuser (or collet body, or gas lens), a liner, and a torch (or body).

As used herein, “MCAW” is defined as metal core arc welding.

As used herein, “GTAW” is defined as gas tungsten arc welding”

As used herein, “consumable”, as pertains to GTAW, includes, but is not limited to: a diffuser (or collet body, or gas lens), a collet, a nozzle (or cup), an electrode (tungsten), a torch (or body), and a power cable.

As used herein, the term “real time” is defined as relating to a system in which input data is processed within milliseconds so that this processed data is virtually immediately available as feedback or output.

The proposed system allows the user to set targets for the amount of filler metal (pounds, kg's etc.) that should be used per a given consumable before replacing it, barring any abnormal event that would cause a premature failure. The targets can be customized for any given weld cell using trial and error to determine the optimum point at which to replace a given consumable based on the amount of filler metal that has been consumed. In some cases, known or established data may also be used as targets.

The proposed Consumable Efficiency Management System consists of a touch screen pad or computer for Human Machine Interface (HMI). The interface allows the user to set targets for the total pounds or kilograms that should be used for a given consumable and reset them individually as each consumable is replaced. The Consumable Efficiency Management System is configured to accept target inputs and real time usage inputs. The Consumable Efficiency Management System is also configured to aggregate the real time usage inputs over time and compare the aggregate usage to the target input as discussed below.

Tracking the amount of filler metal used can be manually entered into the system such as for manual Gas Tungsten Arc Welding. For automated Gas Tungsten Arc Welding, and Gas Metal Arc Welding type processes (including Flux Core and Metal Core Arc Welding), tracking the amount of filler metal used is done automatically by an external or internal wire sensor (wire counter or speed sensor) that is installed on the wire feeder, with a data or communication cable connected to the HMI control. The sensor feeds data regarding the length or weight of the filler metal consumed to the software or program in the HMI control and is continuously tracked and displayed in the control. This data is converted to pounds or kilograms based on the data entered by the end user (such as wire diameter, wire type, etc.) in the sub menu for the filler metal. The system also allows for a second sensor to be attached for tracking the amount of shielding gas consumed per pound or kilogram of filler metal consumed.

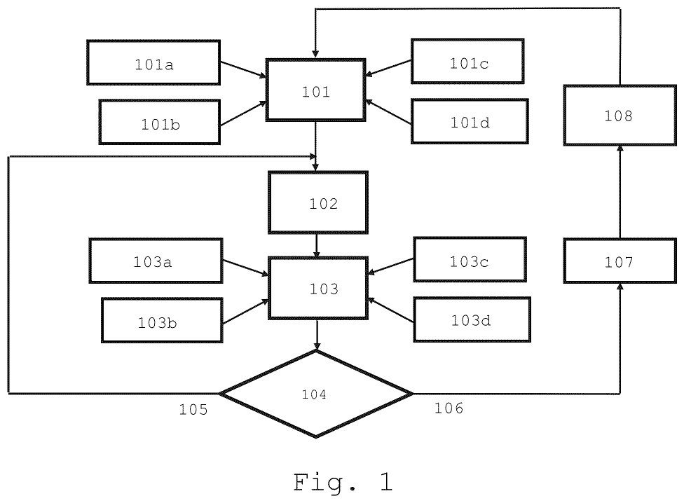

Turning to FIG. 1, one embodiment of the overall process is illustrated. The target filler metal value for the particular consumable is input into the system 101. In a non-limiting example, the consumable may be the target of pounds of wire that is to be put through the diffuser 101a, the target of pounds of wire that is to be put through the liner 101b, the target of pounds of wire that is to be put through the tip 101c, or the target of pounds of wire that is to be put through the nozzle 101d. One skilled in the art will recognize that any particular consumable that is to be managed may be input at this stage.

Then the system is then operated as usual 102. During this normal operation, the real-time usage of the consumables is monitored, and input into the system 103. Again, in this non-limiting example, the consumable may be the aggregate number of pounds of wire that is put through the diffuser 103a, the aggregate number of pounds of wire that is put through the liner 103b, the aggregate number of pounds of wire that is put through the tip 103c, or the aggregate number of pounds of wire that is put through the nozzle 103d.

The actual aggregate values for each consumable is then compared to the target inputs 104. If the actual aggregate value for a particular consumable is not equal to the target filler metal value 105, the system continues to operate as usual 102. However, if the actual aggregate value for a particular consumable is equal to, or greater than, the target filler metal value 105, the process then sends a signal to the operator that it is time to replace that consumable 107. This allows the operator to finish a weld after receiving a signal, with the signal continuing but not to the point where the wire consumed is no longer equal to the target. After the operator replaces that consumable, the process then resets that particular consumable counter 108 to zero, and the process repeats. The operator can reset the consumable counter by pressing wire count reset button for that particular consumable by means of the Human Machine Interface (HMI). Note, that it is not always necessary to input new targets 101, but the operator will have the opportunity at this time to fine tune his workflow.

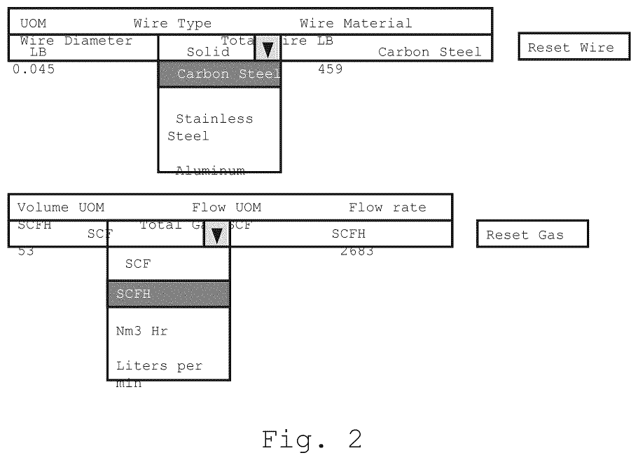

Turning to FIG. 2, one non-limiting example of the operator system interface is represented. In this example, the operator can select the wire parameters, such as the desired units of measurement (i.e. pounds, kilograms, feet of wire, meters of wire, etc.), the wire type (i.e. solid, flux-core, etc.), the wire material (carbon steel, stainless steel, aluminum, etc.), the wire diameter, and possibly the total amount of wire that is being loaded. Since the length of wire or volume of gas is being counted using sensors in real time, it isn't necessary to load new wire or gas in order to select parameters or reset the count. This interface also allows these values to be reset to zero at the start of a run. In this example, the operator can also select parameters for the particular welding gas, such as the desired volumetric unit of measure (i.e. cubic feet per hour (SCF), liters per minute (LPM), etc.), the flowrate units of measure (i.e. cubic feed per hour (SCFH), cubic meters per hour (Nm2 Hr), liters per minute, etc), the gas flowrate, and the total amount of gas that is being loaded. The interface also allows these values to be reset to zero at the start of a run.

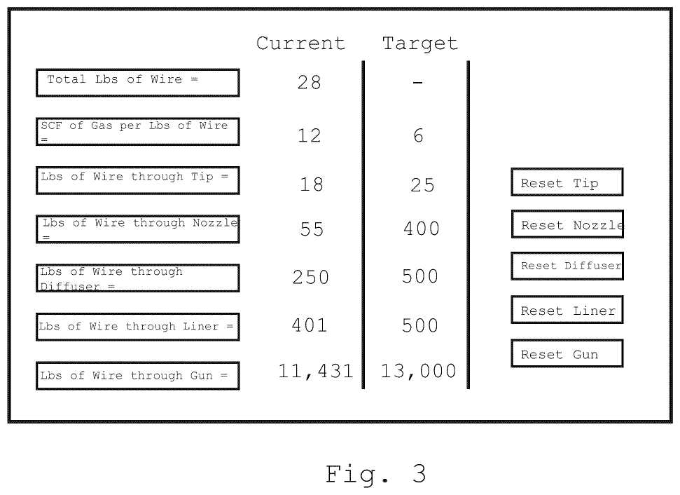

Turning to FIG. 3, in one non-limiting example, the consumable targets 101 and the real-time consumable usage 103 can be monitored by the operator. This interface also allows the consumable targets to be reset to zero.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for monitoring and measuring the amount of filler metal used per a welding consumable, comprising:
a) inputting into a consumable efficiency management system, by means of a human-machine interface, a target filler metal value for at least one welding consumable to be used by a welding system,
b) operating the welding system, thereby producing a real time usage value of the filler metal by the at least one welding consumable,
c) continuously monitoring the real time usage value and continuously inputting the real time usage value into the consumable efficiency management system, thereby producing an aggregate value of the usage of the filler metal by the at least one welding consumable,
d) comparing the aggregate value with the target value, wherein
if the aggregate value is greater than or equal to the target value, the at least one welding consumable is replaced, and the aggregate value of the usage of the filler metal is reset to zero for that consumable,
if the aggregate value is less than the target value, step b), step c), and step d) are repeated.

2. The method of claim 1, wherein the at least one welding consumable is selected from the group consisting of a diffuser, a liner, a tip, and a nozzle.

3. The method of claim 1, wherein the at least one welding consumable is selected from the group consisting of a diffuser, a collet, a nozzle, an electrode, a torch, a power cable.

4. The method of claim 1, wherein one or more parameters for the filler metal may be input into the consumable efficiency management system, by means of a human-machine interface, and is used by the consumable efficiency management system in determining the real time usage value.

5. The method of claim 4, wherein the one or more parameters for the filler metal are selected from the group consisting of wire type, wire material, and wire diameter.

6. The method of claim 1, further comprising continuously monitoring the real time usage of welding gas used per unit of filler metal.

7. The method of claim 1, wherein the continuous monitoring in step c) is performed manually.

8. The method of claim 1, wherein the real time usage value is manually input into the consumable efficiency management system.

9. The method of claim 1, wherein the continuous monitoring in step c) is performed automatically.

10. The method of claim 1, wherein the real time usage value is automatically input into the consumable efficiency management system.

11. A method for monitoring and measuring the amount of filler metal used per a welding consumable, comprising:
a) inputting into a consumable efficiency management system, by means of a human-machine interface, a target filler metal value for at least one welding consumable to be used by a welding system,
b) operating the welding system, thereby producing a real time usage value of the filler metal by the at least one welding consumable,
c) continuously monitoring the real time usage value and continuously inputting the real time usage value into the consumable efficiency management system, thereby producing an aggregate value of the usage of the filler metal by the at least one welding consumable,
d) comparing the aggregate value with the target value, wherein
if the aggregate value is greater than or equal to the target value, the at least one welding consumable is replaced, and the aggregate value of the usage of the filler metal is reset to zero,
if the aggregate value is less than the target value, assess the condition of the at least one welding consumable, and adjust the target value for the at least one welding consumable, and repeat step b), step c), and step d).

12. The method of claim 11, wherein the at least one welding consumable is selected from the group consisting of a diffuser, a liner, a tip, and a nozzle.

13. The method of claim 11, wherein the at least one welding consumable is selected from the group consisting of a diffuser, a collet, a nozzle, an electrode, a torch, a power cable.

14. The method of claim 6, wherein one or more parameters for the filler metal may be input into the consumable efficiency management system, by means of a human-machine interface, and is used by the consumable efficiency management system in determining the real time usage value.

15. The method of claim 14, wherein the one or more parameters for the filler metal are selected from the group consisting of wire type, wire material, and wire diameter.

16. The method of claim 1, further comprising continuously monitoring the real time usage of welding gas used per unit of filler metal.

17. The method of claim 1, wherein the continuous monitoring in step c) is performed manually.

18. The method of claim 1, wherein the real time usage value is manually input into the consumable efficiency management system.

19. The method of claim 1, wherein the continuous monitoring in step c) is performed automatically.

20. The method of claim 1, wherein the real time usage value is automatically input into the consumable efficiency management system.
